(19) United States
(12) Patent Application Publication
(10) Pub. No.: US 2013/0008299 A1
(43) Pub. Date: Jan. 10, 2013

(54) ADJUSTMENT MECHANISM TO PERMIT A USER TO ADJUST THE SPACE BETWEEN HI-HAT CYMBALS

(76) Inventors: William Joseph Coady, Port Hakwesbury (CA); Matthew L. Swan, Point Edward (CA)

(21) Appl. No.: 13/543,753

(22) Filed: Jul. 6, 2012

Related U.S. Application Data
(60) Provisional application No. 61/505,969, filed on Jul. 8, 2011.

(51) Int. Cl. G10D 13/06

(52) U.S. Cl. 84/422.2

(57) ABSTRACT

This invention is an adjustment mechanism for a musical percussion instrument having a pair of upper and lower cymbals moveable along a stand between a fully open position wherein there is a gap between the upper and lower cymbals and a fully closed position wherein there is no gap between the cymbals. The adjustment mechanism comprises a resilient element between the upper and lower cymbals to control the gap therebetween, an actuating mechanism operably connected to the resilient element, and a strike surface operably connected to the actuating mechanism. Striking the strike surface serves to cause movement of the resilient member and alter the gap between the upper and lower cymbals. The gap will increase or decrease depending on which strike surface is struck.

### RELATED APPLICATIONS

This application claims the benefit of U.S. Provisional Application Ser. No. 61/505,969, filed Jul. 8, 2011, entitled ADJUSTMENT MECHANISM TO PERMIT A USER TO ADJUST THE SPACE BETWEEN HI HAT CYMBALS, the entire disclosure of which is herein incorporated by reference.

### FIELD OF THE INVENTION

The present invention relates to the field of percussion instruments. More specifically, the present invention relates to an adjustment mechanism to permit a user to adjust the space between a hi-hat cymbal set during play.

### BACKGROUND OF THE INVENTION

The hi-hat is a percussive musical instrument comprised of two cymbals that face each other on a vertical stand. The gap between the cymbals can be adjusted to produce a range of sounds, as desired by the drummer. The cymbals can be positioned with varying spacing between a fully open position with a maximum predetermined space to a fully closed position wherein the cymbals are in contact with each other.

When hi-hat cymbals are mounted to a hi-hat stand, the drummer, or player, will set the open position of the top cymbal before playing, and then the foot pedal is used to partly or fully close it to create the desired sounds, either by the cymbals hitting each other or with the drum stick hitting the cymbal at various levels of openness. When a drummer has a favorite openness sound for a particular song, the drummer has to find and hold the relative position of the cymbals before hitting them with a stick each time in the song. The use of an extra hi-hat, an X-hat, with the cymbals locked at that favorite openness position can be positioned somewhere on the kit. This X-hat allows the drummer to play that sound at anytime and still play a foot pedal operated hi-hat as needed.

The hi-hat is typically controlled by a foot pedal between the open and closed positions. However, the desired gap between the cymbals when in the open position is set before play begins. Once the desired gap is set, the cymbals are locked during play, and the drummer opens and closes the cymbals using the foot pedal. The drummer will be limited to producing only the set range of sounds possible in a particular pre-set configuration. It is thus desirable to provide a mechanism for adjusting the gap between the cymbals during play so that the drummer can adjust and produce a more broad range of sounds during the course of playing the hi-hat cymbals.

### SUMMARY OF THE INVENTION

This invention overcomes the disadvantages of the prior art by providing an adjustment mechanism which allows a drummer to adjust the gap or space between hi- hat cymbals during play. The adjustment mechanism provides improved freedom by allowing very quick adjustment of the gap between the cymbals without the drummer having to stop playing or use tools. In other words, embodiments of the present invention permit a drummer to adjust the space between cymbals of a hi-hat set during play.

The adjustment mechanism in accordance with the teachings of this invention targets the cymbals located on an X-hat. Now the cymbal gap setting on the X- hat can easily be modified mid-song. The mechanism can also be used with a normal hi- hat.

Using the adjustment mechanism in accordance with the teachings of this invention, the drummer can adjust the gap between the X-hat cymbals by tapping the adjustment bar on one end or the other, either to expand the gap or minimize the gap, thereby easily controlling the type of sound the X-hat gives when hit.

In an illustrative embodiment, the adjusting mechanism includes a pair of upper and lower cymbals that are moveable along a stand between an open position wherein there is a gap between the upper and lower cymbals and a closed position wherein there is no gap between the cymbals. An actuating mechanism connects to a spring or other resilient element between the upper and lower cymbals which controls the gap between the cymbals. The actuating mechanism is controlled by a drummer striking a strike surface connected to the actuating mechanism, causing the resilient member to move in a way that increases or decreases the gap between the cymbals depending on where the point of impact is on the strike surface. The strike surface is on an adjustment bar such that striking the adjustment bar on one side will rotate a rotating cam relative to a rod mount cam and push down on the stem in a manner that decreases the gap between cymbals. Alternatively, striking the adjustment bar on the opposite side will release pressure on the stem and allow the spring to increase the gap between the cymbals. The adjustment mechanism can include two plastic spring ends to protect the cymbals. The upper cymbal is optionally held between two felts by the force of lock nuts.

In a further illustrative embodiment, the actuating mechanism comprises a stem that goes from the top of the spring to a rod mount cam, and a rotating cam is attached to the rod mount cam with a standard drum tensioning rod and a matching nyloc nut. The rod mount cam is locked to a pull rod by a setscrew. The tensioning rod and nyloc nut presents a pivot point for the rotating cam relative to the rod mount cam.

Other aspects and advantages of embodiments of the invention will be readily apparent to those ordinarily skilled in the art upon a review of the following description.

### BRIEF DESCRIPTION OF THE DRAWINGS

The invention description below refers to the accompanying drawings, of which:

FIG. 1 is a perspective side view of an assembled version of an illustrative cymbal adjustment mechanism and instrument, according to an illustrative embodiment of this invention;

FIG. 1a is a cross-sectional side view of the assembled cymbal adjustment mechanism and instrument of FIG. 1;

FIG. 2 is an exploded side view of the illustrative embodiment of the adjustment mechanism of FIG. 1;

FIG. 3 is a side view of the top portion of the cymbal adjustment mechanism of FIG. 1 showing the gap between the cymbals biased into a closed position; and

FIG. 4 is a side view of the top portion of the cymbal adjustment mechanism of FIG. 1 showing the gap between the cymbals biased into an open position.

### DETAILED DESCRIPTION OF THE DISCLOSED EMBODIMENTS

Embodiments of the invention will now be described in conjunction with the accompanying drawings which illustrate various views of a hi-hat cymbal set including an adjustment mechanism in accordance with an embodiment of the invention.

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

The invention description below refers to the accompanying drawings, of which:

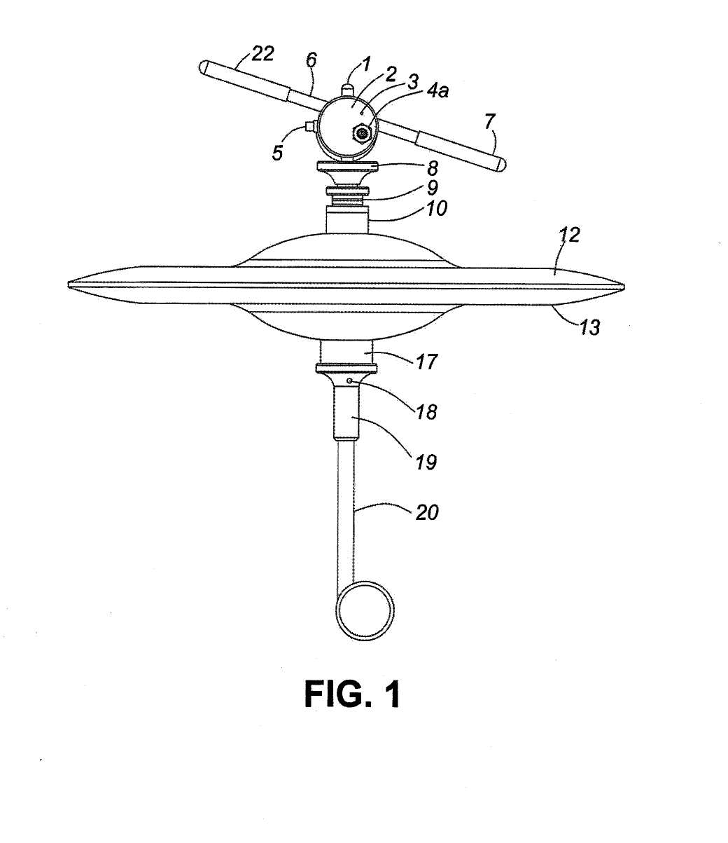

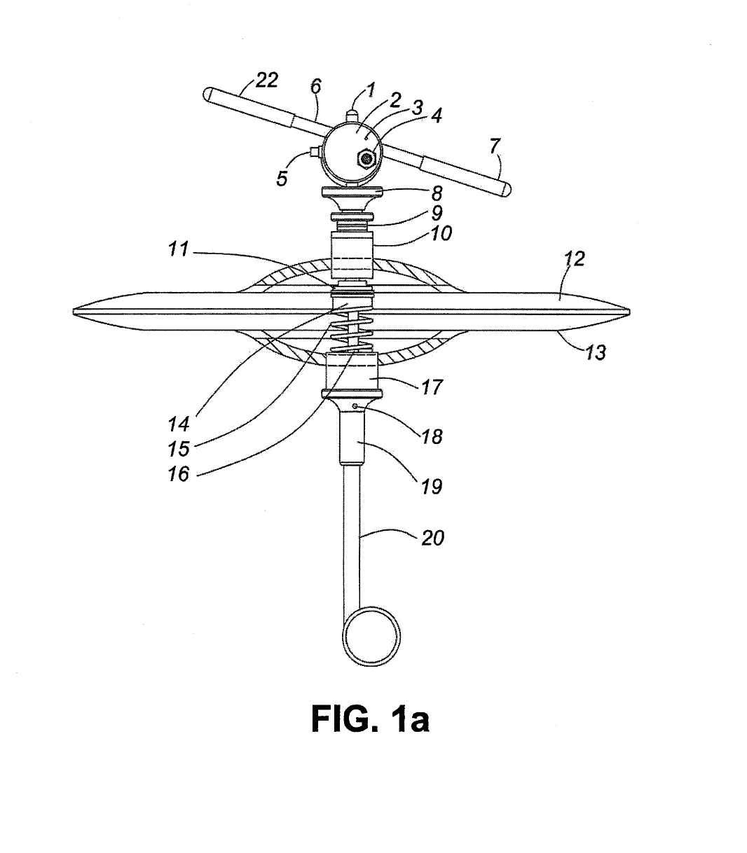

FIG. 1 illustrates a hi-hat cymbal set in accordance with the teachings of this invention. The lower cymbal 13 rests on bottom cymbal felt 17 mounted on stand 20 in a conventional manner.

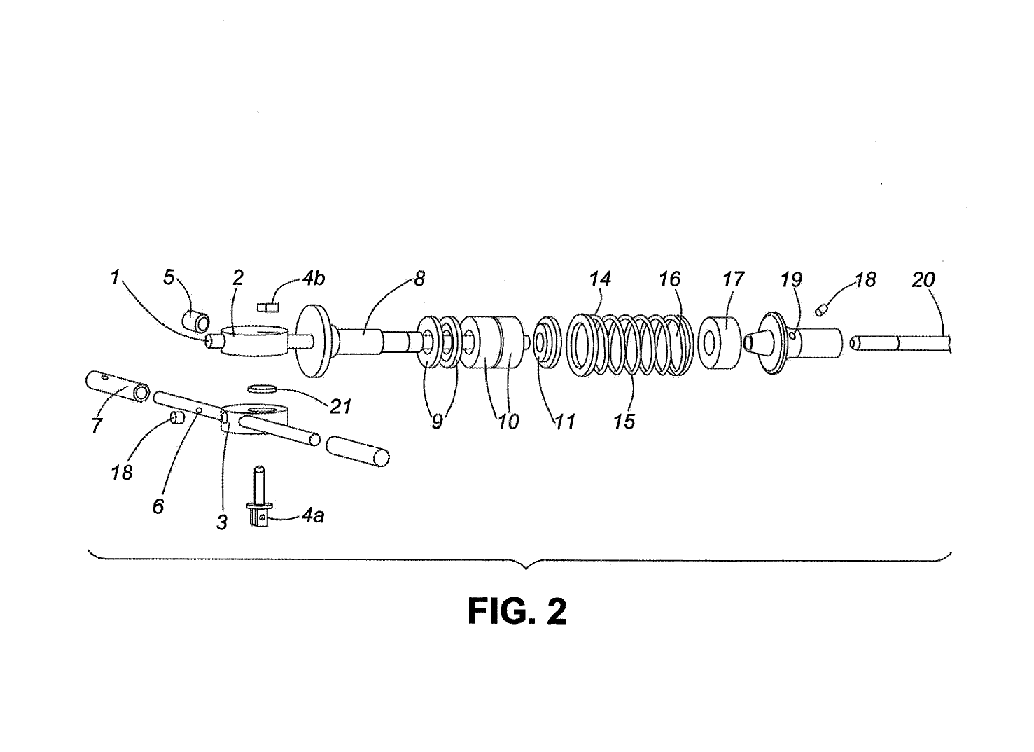

FIG. 1a illustrates a cross-sectional view of the hi-hat cymbal set shown in FIG. 1. Two plastic spring ends 14 and 16 are included to protect the cymbals 12 and 13. The upper cymbal 12 is held between two felts 10 by the force of lock nuts 9 and 11 acting on a stem 8 that goes from the top of the spring 15 to the rod mount cam 2. As shown in both FIGS. 1 a and 2, the rod mount cam 2 is locked to the pull rod 1 by a setscrew 5. The rotating cam 3 is attached to the rod mount cam 2 with a standard drum tensioning rod 4a and a matching nyloc nut 4b (See FIG. 2). This tensioning rod and nyloc nut combo is a pivot point for the rotating cam 3 relative to the rod mount cam 2. Between these two components there is a tension o-ring 21 installed to provide resistance to unwanted rotation once set.

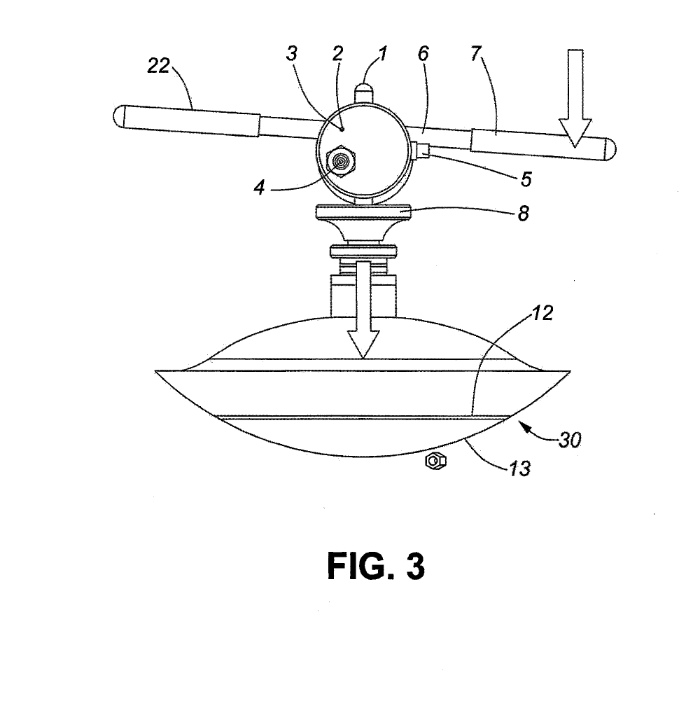

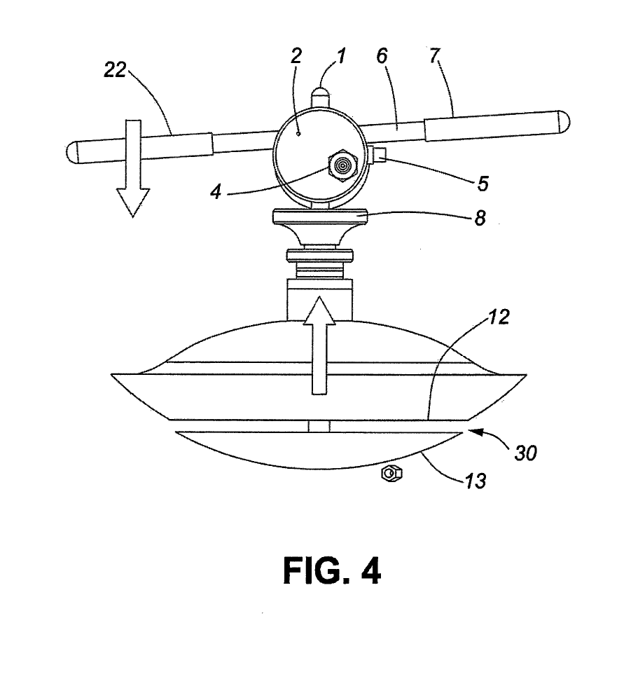

As demonstrated in FIGS. 3 and 4, when adjustment of the X-hat is desired, the drummer uses a drum stick to strike the quiet parts 7 or 22 of the adjustment bar 6. In an exemplary embodiment, FIG. 3 demonstrates that striking quiet part 7 will rotate the rotating cam 3 relative to the rod mount cam 2, thereby pushing down further on the stem 8 and decreasing the gap 30 between cymbals 12 and 13. FIG. 4 demonstrates that striking quiet part 22 on the opposite side of the adjustment bar 6 will rotate the rotating cam 3 relative to the rod mount cam 2 in an alternate direction, thereby releasing pressure on the stem and allowing the spring 15 to increase the gap 30 between the cymbals 12 and 13. A set screw 5 can be provided to secure the components as appropriate.

Also shown in FIGS. 1, 1a, and 2, an M4 set screw 18 is used to secure a cymbal stand adapter 19 to a cymbal stand 20. The X-hat system can be stabilized by securing the cymbal stand adapter 19 in various illustrative manners: a player could secure the cymbal stand adapter 19 to a hi-hat stand; a player could secure the cymbal stand adapter to an X-hat arm that attaches part way up one of the other stands on the kit; and/or a player could secure the cymbal stand adapter 19 in some way to a cymbal stand to hold the extra set of hi-hats.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, the materials and/or fasteners employed in the various components of the assembly are highly variable. Accordingly, this description is meant to be taken only by way of example, and not to otherwise limit the scope of this invention.

What is claimed is:

1. An adjustment mechanism for a musical percussion instrument having a pair of upper and lower cymbals moveable along a stand between a fully open position wherein there is a gap between the upper and lower cymbals and a fully closed position wherein there is no gap between, the adjustment mechanism comprising:
a resilient element between the upper and lower cymbals to control the gap therebetween; an actuating mechanism operably connected to the resilient element;
a strike surface operably connected to the actuating mechanism, wherein striking of the strike surface serves to cause movement of the resilient member to control the gap between the upper and lower cymbals.

2. The adjustment mechanism of claim 1, wherein the resilient member is a spring.

3. The adjustment mechanism of claim 1, further comprising two plastic spring ends are included to protect the cymbals.

4. The adjustment mechanism of claim 1, wherein the upper cymbal is held between two felts by the force of lock nuts.

5. The adjustment mechanism of claim 2, wherein the actuating mechanism comprises: a stem that goes from the top of the spring to a rod mount cam; and a rotating cam is attached to the rod mount cam with a standard drum tensioning rod and a matching nyloc nut.

6. The adjustment mechanism of claim 5, wherein the rod mount cam is locked to a pull rod by a setscrew.

7. The adjustment mechanism of claim 5, wherein the tensioning rod and nyloc nut is a pivot point for the rotating cam relative to the rod mount cam.

8. The adjustment mechanism of claim 1, wherein the strike surface is on a adjustment bar such that a strike with a drum stick of the adjustment bar will rotate the rotating cam relative to the rod mount cam, thereby either pushing down further on the stem and decreasing the gap between cymbals or if hit on the opposite side, releasing pressure on the stem and allowing the spring to increase the gap between the cymbals.

9. A musical percussion instrument comprising an adjustment mechanism for a musical percussion instrument having a pair of upper and lower cymbals moveable along a stand between a fully open position wherein there is a gap between the upper and lower cymbals at a fully closed position wherein there is no gap between, the adjustment mechanism comprising:
a resilient element between the upper and lower cymbals to control the gap therebetween; an actuating mechanism operably connected to the resilient element;
a strike surface operably connected to the actuating mechanism, wherein striking of the strike surface serves to cause movement of the resilient member to control the gap between the upper and lower cymbals.
